(19) United States
(12) Patent Application Publication
(10) Pub. No.: US 2015/0189123 A1
(43) Pub. Date: Jul. 2, 2015

(54) Non-Transitory Storage Medium Storing Scan Program and Information Processing Device

(71) Applicant: Brother Kogyo Kabushiki Kaisha, Nagoya-shi (JP)

(72) Inventor: Masatoshi Kadota, Takahama-shi (JP)

(21) Appl. No.: 14/584,658

(22) Filed: Dec. 29, 2014

(30) Foreign Application Priority Data
Dec. 27, 2013 (JP) 2013-272166

(51) Int. Cl. H04N 1/40

(52) U.S. Cl. CPC H04N 1/40

(57) ABSTRACT

A non-transitory storage medium storing a scan program executable by a computer of an image processing device including a communication portion communicable with a scanning device and a storage portion storing a certain program, the scan program, when executed by the computer, causing the image processing device to execute: determining processing in which is determined whether a pseudo image file is read by the certain program; scan-command transmission processing in which, when the image processing device determines that the pseudo image file is read by the certain program, a scan command is transmitted to the scanning device via the communication portion; scanned-data receiving processing in which the image processing device receives scanned data from the scanning device via the communication portion as a reply to the scan command; and scanned-data writing processing in which the received scanned data is written to the pseudo image file.

### CROSS REFERENCE TO RELATED APPLICATION

The present application claims priority from Japanese Patent Application No. 2013-272166, which was filed on Dec. 27, 2013, the disclosure of which is herein incorporated by reference in its entirety.

### BACKGROUND OF THE INVENTION

1. Field of the Invention

The present invention relates to an information processing device communicable with a scanning device and a non-transitory storage medium storing a scan program executable by a computer of the information processing device.

2. Description of the Related Art

Most of application programs that can be executed by an image processing device such as a personal computer (PC) can call a driver of a device by use of an application programming interface (API). The image processing device provides an output to the driver of the device during execution of the program and performs various operations such as printing using a printer communicable with the image processing device.

### SUMMARY OF THE INVENTION

Some of the application programs that can be read by the image processing device cannot call the API of a scanner driver. Such an application program can read in scanned data according to the following procedure. Initially, the scanner driver is activated by a program that can call the API of the scanner driver, and a scan operation is performed by use of a scanning device communicable with the image processing device. The scanned data obtained in the scan operation is stored in a storage portion of the image processing device. Subsequently, the application program reads in, as a file, the scanned data stored in the storage portion. Thus, when the application program that cannot call the API of the scanner driver reads in the scanned data, very complicated operations are required. Even the application program that can call the API of the scanner driver suffers from the following problem. That is, every time the scanned data is read, a screen for setting the scanner driver is displayed and it is required to check setting values on the screen and to press an Enter button. The invention has been developed in view of the situations. It is therefore an object of the invention to enable reading-in of scanned data in a simplified manner.

The object indicated above may be attained according to one aspect of the invention, which provides a computer-readable non-transitory storage medium storing a scan program executable by a computer of an image processing device including a communication portion configured to be communicable with a scanning device and a storage portion configured to store a certain program, the scan program, when executed by the computer, causing the image processing device to execute: determining processing in which the image processing device determines whether a pseudo image file is read by the certain program; scan-command transmission processing in which, when the image processing device determines that the pseudo image file is read by the certain program in the determining processing, the image processing device transmits a scan command to the scanning device via the communication portion; scanned-data receiving processing in which the image processing device receives scanned data from the scanning device via the communication portion as a reply to the scan command; and scanned-data writing processing in which the image processing device writes the scanned data received from the scanning device to the pseudo image file.

The object indicated above may be attained according to another aspect of the invention, which provides an image processing device comprising: a communication portion configured to be communicable with a scanning device; and a controller, wherein the controller is configured to: determine whether a pseudo image file is read by a certain program; transmit a scan command to the scanning device via the communication portion when the controller determines that the pseudo image file is read by the certain program; receive scanned data from the scanning device via the communication portion as a reply to the scan command; and write the scanned data received from the scanning device to the pseudo image file.

### BRIEF DESCRIPTION OF THE DRAWINGS

The objects, features, advantages, and technical and industrial significance of the present invention will be better understood by reading the following detailed description of the embodiments of the invention, when considered in connection with the accompanying drawings, in which:

FIG. 1 is a block diagram of a communication system according to one embodiment of the invention;

FIG. 2 is a view showing a setting-value change screen;

FIG. 3 is a view showing a setting-value input screen;

FIG. 4 is a flow chart showing processing of a PC according to the first embodiment;

FIG. 5 is a flow chart showing processing of the PC according to the first embodiment;

FIG. 6 is a flow chart showing processing of the PC according to the first embodiment;

FIG. 7 is a flow chart showing processing of the PC according to the first embodiment;

FIG. 8 is a flow chart showing processing of the PC according to the first embodiment;

FIG. 9 is a flow chart showing processing of the PC according to the first embodiment;

FIG. 10 is a flow chart showing processing of the PC according to the first embodiment;

FIG. 11 is a view showing a setting-value input screen;

FIG. 12 is a view showing a pipe-name input screen;

FIG. 13 is a flow chart showing processing of the PC according to the second embodiment;

FIG. 14 is a flow chart showing processing of the PC according to the second embodiment;

FIG. 15 is a flow chart showing processing of the PC according to the second embodiment;

FIG. 16 is a view showing a setting-value input screen;

FIG. 17 is a flow chart showing processing of the PC according to a third embodiment; and

FIG. 18 is a flow chart showing processing of the PC according to a modified example.

### DETAILED DESCRIPTION OF THE EMBODIMENTS

### <Configuration of Communication System>

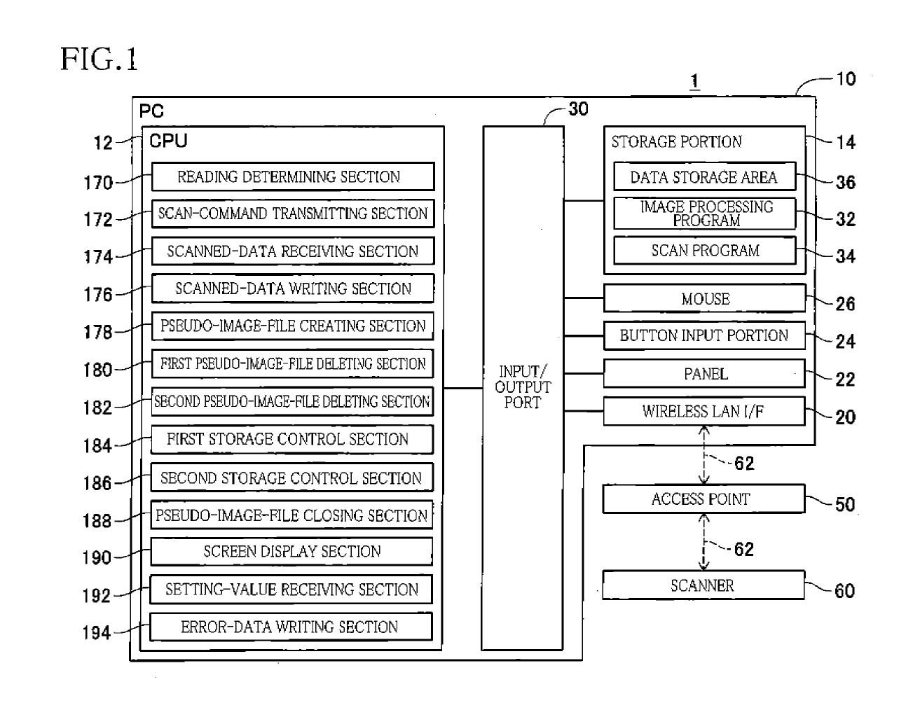

FIG. 1 is a block diagram showing a communication system 1 according to a first embodiment of the invention. The communication system 1 includes a personal computer (PC) 10 as one example of an image processing device of the invention, an access point 50, and a scanner 60 (as one example of a scanning device of the invention). Each of the PC 10 and the scanner 60 can serve as a well-known wireless-LAN terminal device. The PC 10 and the scanner 60 can perform data transmission and reception therebetween via the access point 50. The scanner 60 executes a scan operation based on data transmitted from the PC 10.

Configuration of the PC 10 will be explained. The PC 10 mainly includes a central processing unit 12 (CPU) as one example of a controller and a computer of the invention, a storage portion 14 as one example of a storage portion, a wireless LAN I/F 20 as one example of a communication portion, a panel 22 as one example of a display, a button input portion 24, and a mouse 26 as one example of an input portion. These elements are communicable with one another via an input/output port 30.

The wireless LAN I/F 20 can perform wireless communication 62 (data communication using radio waves) according to a wireless LAN scheme in an infrastructure mode in which a plurality of wireless-LAN terminal devices perform data communication via access points. The wireless communication 62 is based on a Wi-Fi (R) scheme according to the IEEE 802.11 standard or any standard equivalent thereto. (Wi-Fi is a registered trademark of Wi-Fi Alliance.) The scanner 60 can also perform the wireless communication 62. Thus, when the PC 10 accesses the access point 50 and the wireless communication 62 based on wireless LAN becomes available, the PC 10 can perform data communication with the scanner 60.

The CPU 12 executes processing according to an image processing program 32 (as one example of a certain program) or a scan program 34 (as one example of a scan program) stored in the storage portion 14. The image processing program 32 is a program for processing image data. The scan program 34 is a program for causing the scanner 60 to execute a scan operation for obtaining scanned data. In the following description, the CPU 12 that executes the program such as the image processing program 32 or the scan program 34 will be described simply by the program name. For instance, “the image processing program 32 executes” may mean “the CPU 12 executing the image processing program 32 executes”. The storage portion 14 is constituted by a combination of elements such as random access memory (RAM), read only memory (ROM), flash memory, a hard disk (HDD), and a buffer of the CPU 12. The storage portion 14 has a data storage area 36 (as one example of a predetermined area of the invention). Various sorts of data such as scanned data obtained by the scanner 60 and data necessary for execution of the programs 32, 34 are stored in the data storage area 36.

Images and the like based on image data are displayed on the panel 22. The button input portion 24 is constituted by a keyboard and accepts a button operation by a user. Characters and the like input through the button input portion 24 are displayed on the panel 22. The mouse 26 is for moving a pointer displayed on the panel 22 and accepts a click operation by the user.

### <Acquisition of Scanned Data Utilizing Named Pipe>

The image processing program 32 is configured to read an image file and to process image data contained in the image file. The image processing program 32 does not have a function of calling an application program interface (API) of a scanner driver and a function of directly controlling the scanner. Such configuration is typical in an image uploader or the like. For enabling such an image processing program to read a scanned image, a named pipe is utilized in the present embodiment. The named pipe is one example of a pseudo image file of the invention.

The named pipe is a file having the following characteristics:

(1) Data written in the named pipe is read out in first-in-first-out order.
(2) Data read out from the named pipe is deleted from the named pipe.
(3) When file opening is commanded with respect to the named pipe in a write blocking mode, opening processing is delayed until another process performs reading with respect to the named pipe.
The named pipe is typical in Unix (registered trademark) and Linux (registered trademark).

The scan program 34 is installed on the PC 10, and the scanned image is sent to the image processing program 32 via the named pipe through the use of the scan program 34. The image processing program 32 reads in the named pipe as a file in the same way as when reading in typical image files, so as to read in the scanned image.

Setting and creation of a file name and scanning conditions for each named pipe will be explained below. The setting and creation executed as initial setting prior to activation of the image processing program 32 are executed by activating the scan program 34 in a setting mode.

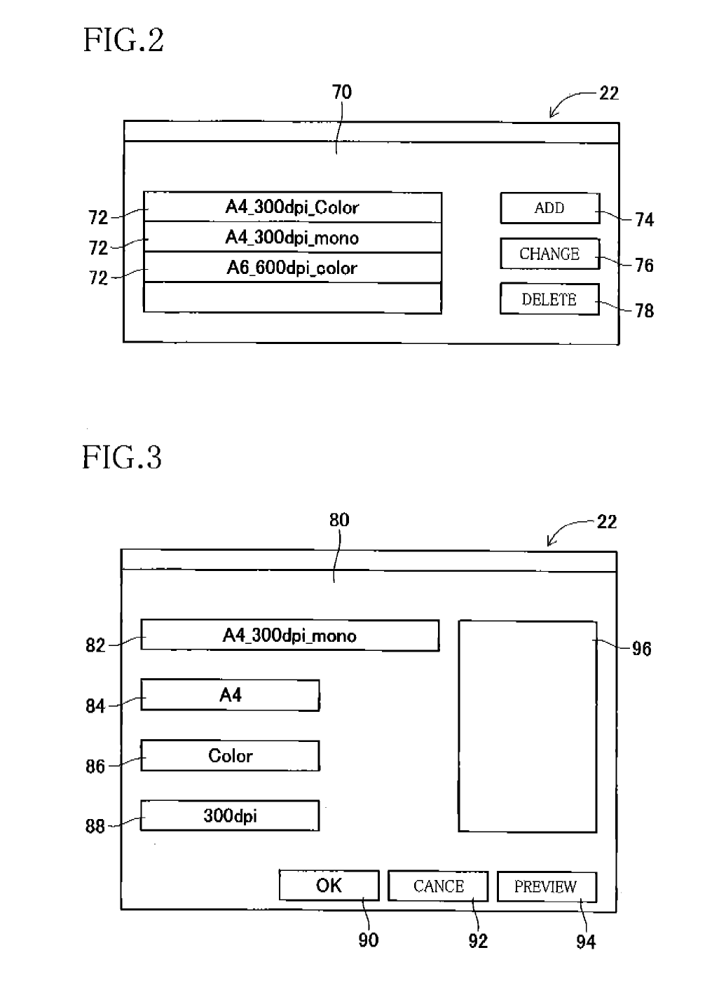

The scan program 34 sets a pipe name for each named pipe to be created and sets setting values of a scan operation by the scanner 60, for each of named pipes having mutually different pipe names. More specifically, when the setting values of the scan operation are set, a setting-value change screen 70 shown in FIG. 2 is displayed on the panel 22. There are displayed, on the setting-value change screen 70, a plurality of pipe-name select buttons 72, an Add button 74, a Change button 76, and a Delete button 78.

The pipe-name select button 72 is a button for selecting a pipe name, i.e., a name of the named pipe. The Add button 74 is a button for setting a new pipe name. The Change button 76 is a button for changing the setting values of the scan operation already set for the pipe name. The Delete button 78 is a button for deleting the setting values of the scan operation already set for the pipe name. After the pointer of the mouse 26 is moved onto any button to be operated, the button is operated by a click operation using the mouse 26.

When the Add button 74 is operated, a setting-value input screen 80 shown in FIG. 3 is displayed. There are displayed, on the setting-value input screen 80, a pipe-name display area 82, a scan-size select button 84, a scan-color select button 86, a scan-resolution select button 88, an OK button 90, a Cancel button 92, a Preview button 94, and a preview area 96.

The scan-size select button 84 is a button for setting a size of a document or original to be scanned. Operating the scan-size select button 84 causes a pull-down list including a plurality of candidates such as A3, A4, and A5 to be displayed. The user selects a desired size from among the plurality of candidates. The scan-color select button 86 is a button for setting a color in scanning. Operating the scan-color select button 86 causes a pull-down list including two candidates, i.e., color and monochrome, to be displayed. The user selects a desired one of the two color settings. The scan-resolution select button 88 is a button for setting scan resolution. Operating the scan-resolution select button 88 causes a pull-down list including a plurality of candidates such as 300 dpi, 400 dpi, and 500 dpi to be displayed. The user selects desired resolution from among the plurality of candidates.

After the setting values of the scan operation are selected by the button operations on the scan-size select button 84 etc., the OK button 90 is operated, so that a pipe name in accordance with the selected setting values is added as a new pipe-name select button 72, and a setting file including the pipe name and the setting values is created and stored in the data storage area 36. The pipe name has an extension indicative of an image format attached thereto.

The setting-value input screen 80 is displayed also when a desired pipe name is selected by operating the corresponding pipe-name select button 72 on the setting-value change screen 70 and the Change button 76 is subsequently operated. After the setting values of the scan operation are selected by the button operations on the scan-size select button 84, etc., on the setting-value input screen 80, and the OK button 90 is subsequently operated, the setting values of the scan operation set for the existing pipe name are changed.

When a desired pipe name is selected by operating the corresponding pipe-name select button 72 on the setting-value change screen 70 and the Delete button 78 is subsequently operated, the setting values of the scan operation set for the selected pipe name are deleted.

In later-explained processing, a named pipe is created for each pipe name set by use of the setting-value change screen 70 and the setting-value input screen 80. Specifically, the scan program 34 is executed to read in the set pipe names, and the setting values of the scan operation for each pipe are extracted. Each named pipe in accordance with the setting values of the scan operation is stored in the data storage area 36. A command for creating the named pipe is “mkfifo(file name, PERMISSION)”.

There will be next explained processing when activating the scan program 34 in a resident mode. The activation of the scan program 34 in the resident mode needs to be usually executed only at start-up of the PC 10. However, when the scan program 34 is activated in the setting mode and the settings are changed as descried above, the scan program 34 needs to be activated again in the resident mode. When the scan program 34 is activated in the resident mode, the named pipe is created based on the setting file created in the setting mode. Subsequently, a blocking mode is set for the created named pipe, and the opening processing is executed. When a reading request is externally made to the named pipe, namely, when the image processing program 32 makes a reading request to the named pipe, the named pipe is set in a wait condition list with respect to a wait function (“select” function). Here, “select” function means “select” function in the C language.

When the named pipe is created according to the above procedure, the “PERMISSION” is set to “644”. Specifically, “mode_t” in the command “mkfifo(const char *pathname, mode_t mode)” is set to “644”. Thus, writing to the named pipe is allowed only by the scan program 34, and writing to the named pipe by programs other than the scan program 34 is not allowed. That is, only reading of the named pipe is allowed for programs other than the scan program 34 such as the image processing program 32. The scan program 34 is an owner of the named pipe, and reading of and writing to the named pipe by the scan program 34 are allowed. This is because the resident mode is activated by another user different from a usual user.

When the image processing program 32 performs reading with respect to the named pipe set in the wait condition list described above, the named pipe with respect to which the image processing program 32 has performed reading is identified, and the setting values of the scan operation set for the named pipe are obtained. Subsequently, a command of the scan operation, i.e., scan command, based on the obtained setting values is transmitted to the scanner 60 via the wireless LAN I/F 20.

The scanner 60 that has received the scan command performs the scan operation according to the setting values received together with the command and creates the scanned data. The created scanned data is transmitted from the scanner 60 to the PC 10 through the wireless communication 62. Upon reception of the scanned data, the scan program 34 stores the received scanned data in a temporary file in the data storage area 36. The scan program 34 converts the format of the scanned data according to the extension.

Subsequently, the scan program 34 reads the scanned data that has undergone format conversion from the temporary file and writes the read scanned data to the named pipe with respect to which the image processing program 32 has performed reading. Thus, the scanned data written to the named pipe is obtained by use of the image processing program 32. In other words, the image processing program 32 can read in the scanned data created by the scanner 60 in the same way as when reading in typical image files.

The scan operation by the scanner 60 is not sometimes performed properly. For example, the scan operation is not performed by the scanner 60 and the scan program 34 accordingly cannot obtain the scanned data in cases such as when data transmission and reception through the wireless communication 62 is not available between the PC 10 and the scanner 60, when no document is set on the scanner 60, and when the scanner 60 is not turned on. In such cases, the scan program 34 writes image data indicative of an error to the named pipe with respect to which the image processing program 32 has performed reading. Consequently, the image processing program 32 executes processing that is to be executed when the scanned data cannot be obtained, on the basis of the image data indicative of the error written to the named pipe.

When writing of the scanned data or the image data indicative of the error to the named pipe ends, the named pipe is disabled. That is, the named pipe is closed and is deleted from the data storage area 36. It is noted, however, that the deleted named pipe is again created according to the manner described above and becomes available. In this respect, the scanned data stored in the temporary file is also deleted.

### <Scan Program>

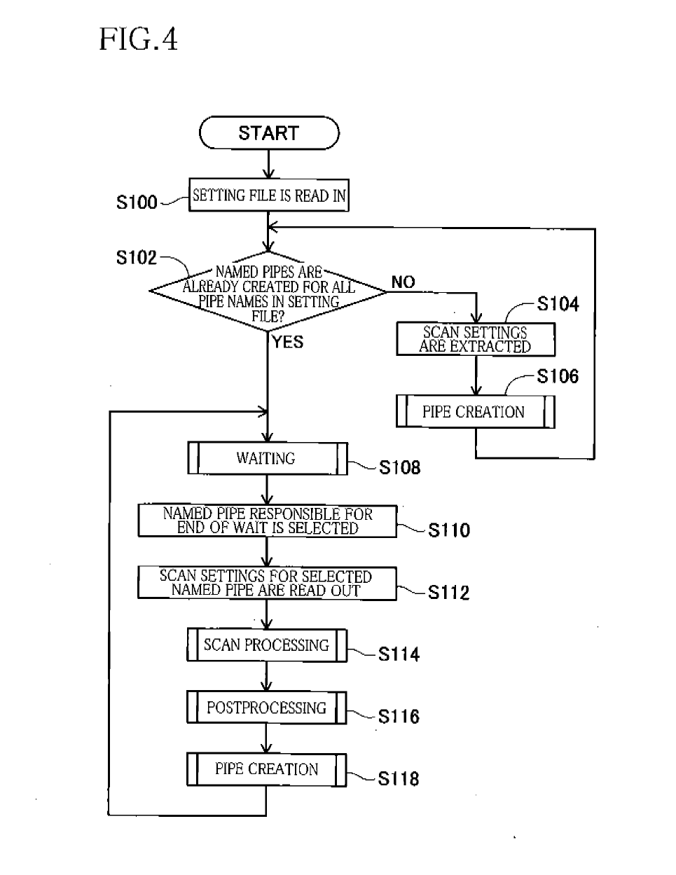

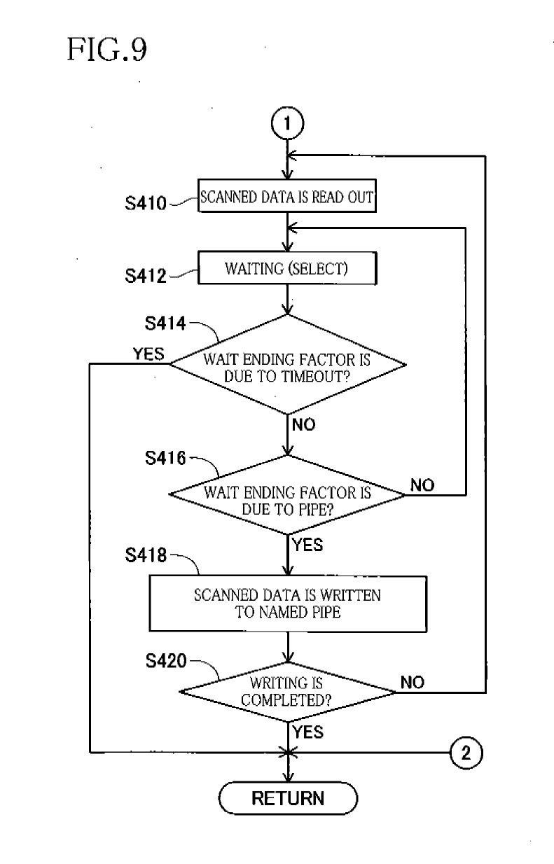

The above-indicated creation of the named pipe and acquisition of the scanned data utilizing the named pipe is executed by execution of the scan program 34 in the CPU 12 of the PC 10. Referring to flow charts of FIGS. 4-10, processing when the scan program 34 is executed in the CPU 12 will be explained below. Processing executed in the setting mode is less relevant to the principle of the invention and its explanation is dispensed with.

When the scan program 34 is executed in the resident mode, the setting file is read in (Step 100). (Hereinafter “Step” is abbreviated as “S”). The setting file is created when the scan program 34 is activated in the setting mode. In the setting file, the pipe name and the setting values set for the pipe name are described. It is subsequently determined whether named pipes are already created for all of the pipe names described in the setting file (S102). If any pipe name for which the named pipe is not yet created exists in the setting file (S102: NO), the pipe name and the setting values of the scan operation are extracted from the setting file (S104) and a pipe creating sub routine is executed based on the extracted pipe name and setting values of the scan operation (S106).

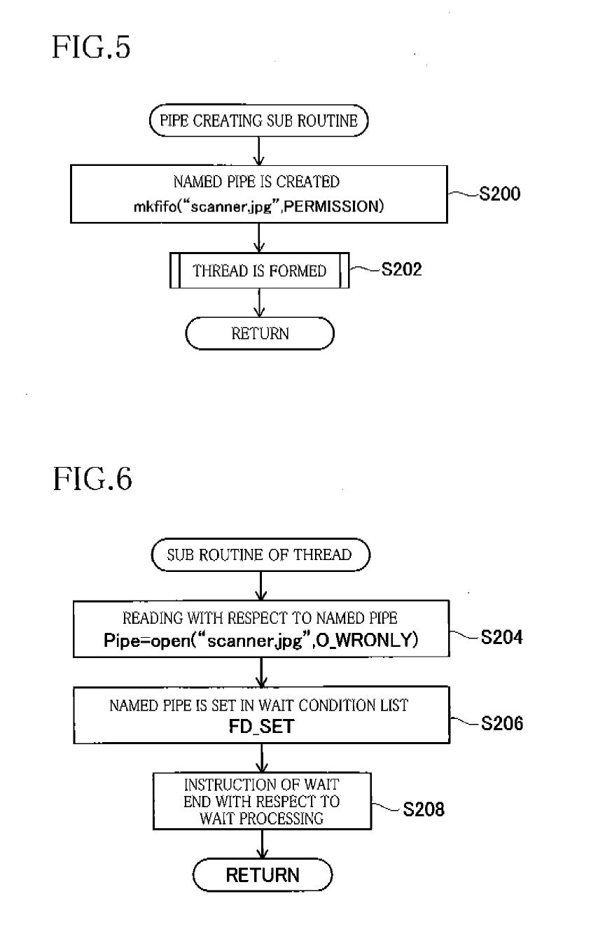

The named pipe is created in the pipe creating sub routine, as shown in FIG. 5 (S200). A command for creating the named pipe is “mkfifo(file name, PERMISSION)”. Then a thread is formed (S202), and the pipe creating sub routine ends. The routine of the thread formed at S202 is executed concurrently with the processing shown in FIG. 4. As shown in FIG. 6, the opening processing is executed on the named pipe created at S200 (S204). In this instance, a write-only mode and the blocking mode are set. The blocking mode is a mode in which any associated processing is suspended until writing is allowable. When opening is commanded in this mode, this opening processing is blocked or suspended until the image processing program performs reading with respect to the named pipe. When the opening processing ends, in other words, when a reading request is externally made to the named pipe, namely, the image processing program performs reading with respect to the named pipe, the named pipe is set in a wait condition list with respect to a wait function (“select” function) (S206). This processing is executed by an FD_SET macro. Thereafter, the scan program 34 instructs an end of wait with respect to wait processing (S300) that will be later explained (S208), and the sub routine of the thread ends.

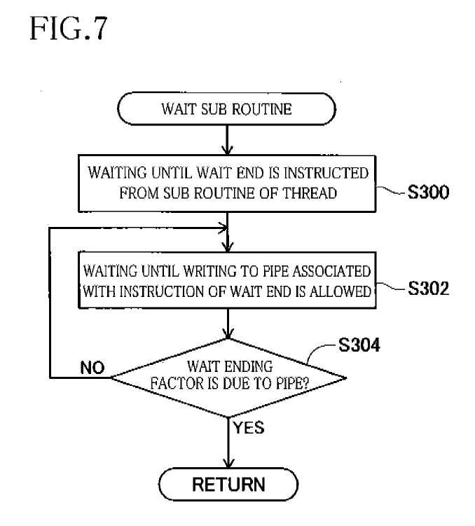

If the named pipe is already created for each of all of the pipe names in the setting file at S102 (S102: YES), a wait sub routine is executed (S108). In the wait sub routine, the scan program 34 waits until the end of wait is instructed from the sub routine of the thread, as shown in FIG. 7 (S300). When the pipe creating sub routine is executed for each of the plurality of named pipes, the scan program 34 waits until the end of wait for any one of the pipes is instructed. The instruction of the end of wait causes the processing to proceed to S302. At S302, the scan program 34 waits until writing to the pipe associated with the instruction of the end of wait is allowed (S302). When writing is allowed, S304 is implemented at which it is determined whether a wait ending factor is due to the pipe (S304). S304 is implemented by use of the “select” function. The reason for implementation of S304 is that the “select” function indicates in some cases that another factor different from the pipe causes cancellation of the wait. If the wait ending factor indicated by the “select” function is not due to the pipe (S304: NO), the processing returns to S302 at which the scan program 34 continues to wait. If the wait ending factor, namely, the ending factor indicated by the “select” function, is due to the pipe (S304: YES), the wait sub routine ends.

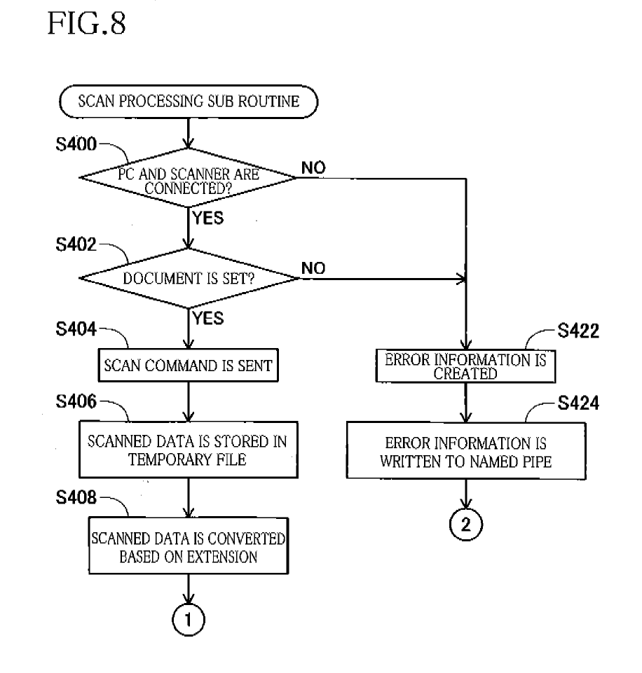

When the wait sub routine ends, the processing returns to a main routine and the named pipe that is responsible for the end of wait is selected (S110). The setting values of the scan operation for the selected named pipe are read out from the setting file (S112). Subsequently, the scan processing sub routine is executed (S114). In the scan processing sub routine shown in FIG. 8, the CPU 12 initially determines whether the PC 10 is being connected to the scanner 60, namely, whether data transmission and reception therebetween are available (S400).

If data transmission and reception are available between the PC 10 and the scanner 60 (S400: YES), the CPU 12 determines whether any document is set on the scanner 60 (S402). If any document is set on the scanner 60 (S402: YES), the scan command is sent to the scanner 60 via the wireless LAN I/F 20 (S404). The CPU 12 receives the scanned data as a reply to the scan command and stores the received scanned data in a temporary file in the data storage area 36 (S406).

Thereafter, the image format of the scanned data is converted into the one corresponding to the extension of the selected named pipe (S408). The format-converted scanned data is read out from the temporary file (S410). The reading of the scanned data is performed for every block having a predetermined data amount. Then the scan program 34 is placed in a wait state (S412). The condition for ending the wait state is the same as that at S302. That is, the scan program 34 waits until the data written at S418 (that will be explained) is read by the image processing program and the data can be thus written to the named pipe. In an instance where the wait sub routine is called at S412, S302 is directly implemented without waiting for a new instruction at S300. This is because the end of wait is already instructed at S208. Subsequently, the CPU 12 determines whether the wait state has ended. If the wait state has ended, the CPU 12 determines whether a factor of ending of the wait state (ending factor) is due to a timeout (S414). If the ending factor of the wait state is not due to the timeout (S414: NO), the CPU 12 determines whether the ending factor of the wait state is due to the named pipe (S416). If the ending factor of the wait state is not due to the named pipe (S416: NO), the processing returns to S412.

If the ending factor of the wait state is due to the named pipe (S416: YES), the scanned data is written to the named pipe (S418). The CPU 12 subsequently determines whether writing of all of the scanned data has been completed (S420). If writing of the scanned data is not yet completed (S420: NO), the processing returns to S410 and the next data block is processed similarly. If writing of all of the scanned data has been completed (S420: YES), the scan processing sub routine ends.

If it is determined at S414 that the ending factor of the wait state is due to the timeout (S414: YES), the scan processing sub routine ends.

If it is determined at S400 that data transmission and reception between the PC 10 and the scanner 60 are not available (S400: NO) or if it is determined at S402 that no document is set on the scanner 60 (S402: NO), the image data indicative of the error is created (S422). The image data indicative of the error is written to the named pipe (S418), and the scan processing sub routine ends.

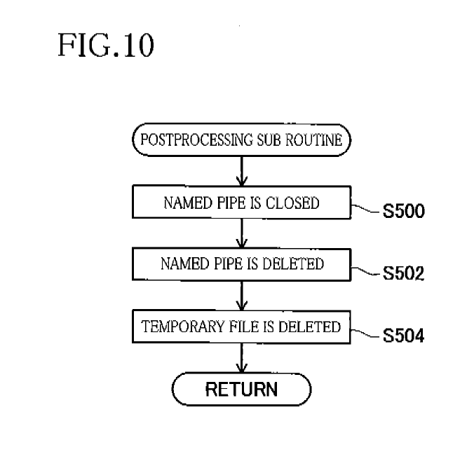

When the scan processing sub routine ends, the processing returns to the main routine, and a postprocessing sub routine is executed (S116). In the postprocessing sub routine shown in FIG. 10, the named pipe is disabled, namely, closed (S500). Subsequently, the closed named pipe is deleted from the data storage area 36 (S502), and the scanned data stored in the temporary file is deleted (S504). Thus, the postprocessing sub routine ends.

When the postprocessing sub routine ends, the processing returns to the main routine, and the pipe creating sub routine is executed (S118). In the pipe creating sub routine of S118, a pipe whose name is the same as the deleted named pipe is created. The manner of creation is substantially the same as in the pipe creating sub routine of S106, and its explanation is dispensed with. When the pipe creating sub routine of S118 ends, the processing returns to S108.

### Second Embodiment

When the scanned data is obtained a plurality of times at the same settings of the scan operation, pseudo files used in reading by the image processing device have the same name in the illustrated first embodiment. In an instance where the image processing program is configured to upload image files to a server, a plurality of images are uploaded with the same file name. This may cause troubles depending upon the configuration of the server. A second embodiment of the invention can avoid such troubles. There will be explained below acquisition of the scanned data using the scan program 34 in the PC 10 according to the second embodiment. The PC 10 of the second embodiment is substantially identical in configuration with the PC 10 of the first embodiment except that a scanner driver is installed on the PC 10 of the second embodiment, and an explanation thereof is dispensed with.

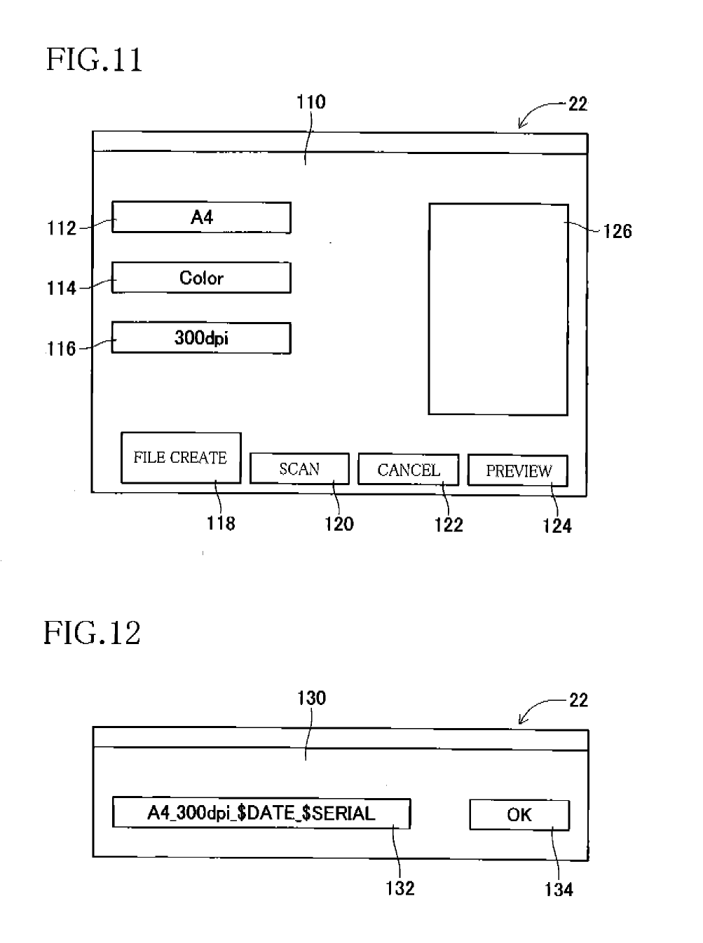

The scanner driver of the PC 10 according to the second embodiment incorporates a function corresponding to the setting mode in the first embodiment. Specifically, execution of the scanner driver by a program that can call a scan API causes a setting-value input screen 110 to be displayed on the panel 22, as shown in FIG. 11. The setting-value input screen 110 is a screen through which are set setting values used when the scan operation is performed using the scanner driver. There are displayed, on the setting-value input screen 110, a scan-size select button 112, a scan-color select button 114, a scan-resolution select button 116, a File Create button 118, a Scan button 120, a Cancel button 122, a Preview button 124, and a preview area 126.

The scan-size select button 112, the scan-color select button 114, the scan-resolution select button 116 are respectively similar to the scan-size select button 84, the scan-color select button 86, and the scan-resolution select button 88 displayed on the setting-value input screen 80 in the first embodiment. The setting values of the scan operation are selected by button operations on those buttons, and the scan operation based on the selected setting values is performed by operating the Scan button 120. When the File Create button 118 is clicked in a state in which the settings are established, the setting file is created as in the setting mode of the first embodiment. Once the File Create button 118 is clicked, the scan operation can be thereafter performed as in the first embodiment if the image processing program 32 performs reading with respect to the named pipe as in the first embodiment even though the image processing program 32 cannot call the API of the scanner driver.

Specifically, operating the File Create button 118 causes a pipe-name input button 130 to be displayed on the panel 22, as shown in FIG. 12. A pipe-name input area 132 and an OK button 134 are displayed on the pipe-name input button 130. A template of the pipe name is input to the pipe-name input area 132 by a user's operation. The template of the pipe name may include a macro for information relating to a setting date ($DATE) (as one example of time-related information of the invention) and a macro for information relating to a serial number ($SERIAL). The macros are replaced with character strings of the corresponding information when the scan program is activated in the resident mode. Subsequently, the OK button 134 is operated, so that the template of the pipe name that is being displayed in the pipe-name input area 132 is set.

When the scan program is activated in the resident mode, the named pipe is created based on the template of the pipe name set by use of the pipe-name input button 130. Specifically, the set template of the pipe name is read by execution of the scan program 34, and a pipe name is created in accordance with the template. For instance, in a case in which the template is “A4_{—}300dpi_$DATE_$SERIAL” and a creation date of the named pipe is Nov. 20, 2013, the pipe name is set to “A4_{—}300dpi_{—}2013_{—}11_{—}20_{—}001”, and the named pipe having the pipe name is created in the data storage area 36.

For the named pipe having the pipe name that contains information relating to the creation date, the wait ending factor includes date changing. When the date changes, the named pipe is deleted from the data storage area 36. Specifically, the pipe name “A4_{—}300dpi_{—}2013_{—}11_{—}20_{—}001” indicates that the named pipe was created on Nov. 20, 2013. If scanned data obtained on Nov. 21, 2013 is written to the named pipe, for instance, the user may confuse. Accordingly, the PC 10 is configured such that, when the date changes to Nov. 21, 2013, the named pipe having the pipe name “A4_{—}300dpi_{—}2013_{—}11_{—}20_{—}001” is deleted from the data storage area 36. Thereafter, the serial number is reset, and a pipe name having a new date is created.

Where the template of the pipe name contains information relating to a serial number ($SERIAL), the file name of the temporary file is changed to the pipe name of the named pipe, and the scanned data in the temporary file is stored without being deleted. Thus, the scanned data used in the image processing program 32 is stored in the temporary file of the data storage area 36, and the scanned data can be easily distinguished based on the file name of the temporary file. It is noted that, when a new named pipe is created, the serial number is incremented.

The creation of the named pipe having the pipe name based on the template, the deletion of the named pipe resulting from the date changing, the storage of the scanned data in the temporary file, etc., are executed by execution of the scan program 34 by the CPU 12 of the PC 10 according to the second embodiment. There will be explained below processing when the scan program 34 of the second embodiment is executed. The processing when the scan program 34 of the second embodiment is executed is the same as the processing when the scan program 34 of the first embodiment is executed, except for the pipe creating sub routine, the wait sub routine, and the postprocessing sub routine. In view of this, the processing in the pipe creating sub routine, the wait sub routine, and the postprocessing sub routine will be explained below referring to the flow charts of FIGS. 12-14.

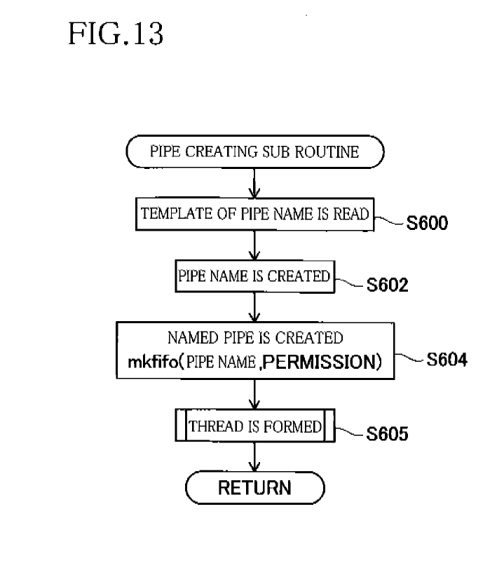

When the pipe creating sub routine is executed, the CPU 12 reads the template of the pipe name, as shown in FIG. 13 (S600). Subsequently, a pipe name is created based on the read template (S602). In this instance, “$DATE” in the template is replaced with information indicative of the date of creation of the pipe name, such as “2013_{—}12_{—}25”. Further, “$SERIAL” in the template is replaced with a serial number starting from “001” as an initial value. At S604 and S605, the same processing executed at S200 and S202 shown in FIG. 5 is executed. Thus, the pipe creating sub routine ends. The routine of the thread formed at S605 executes the same processing as shown in FIG. 6.

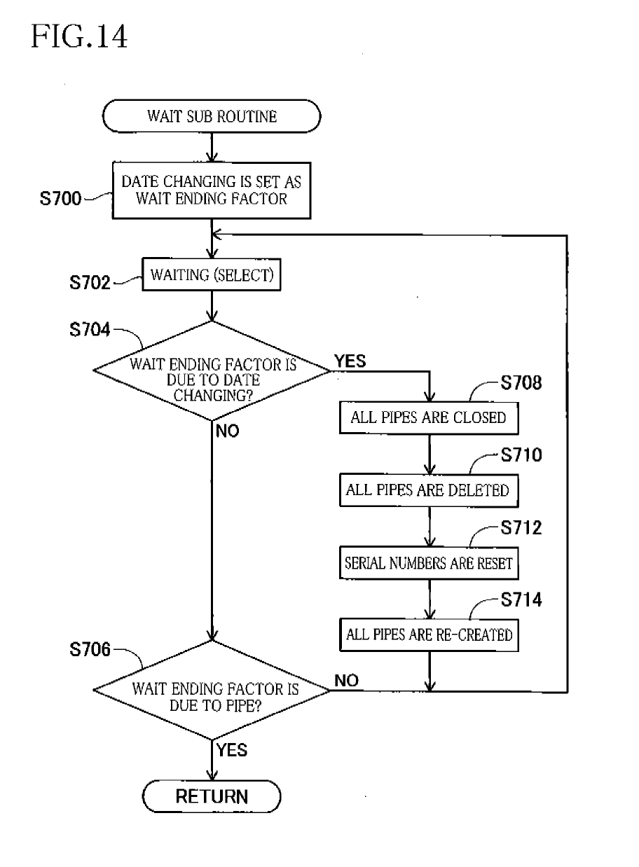

When the wait sub routine is executed, the CPU 12 sets the date changing as the wait ending factor, in addition to the writing permission conditions and the notification of the opening processing with respect to the pipe, i.e., the processing at S204 in the first embodiment, as shown in FIG. 14 (S700). Then the scan program 34 is placed in a wait state (S702). Subsequently, the CPU 12 determines whether the wait state has ended. If it is determined that the wait state has ended, the CPU 12 then determines whether the ending factor of the wait state is due to the date changing (S704). If the ending factor of the wait state is not due to the date changing (S704: NO), the CPU 12 determines whether the ending factor of the wait state is due to the named pipe (S706). In other words, the CPU 12 determines whether the wait state has ended because of an occurrence of reading with respect to the named pipe. If the ending factor of the wait state is not due to the named pipe (S706: NO), the processing returns to S702. If the ending factor of the wait state is due to the named pipe (S706: YES), the wait sub routine ends.

If it is determined at S704 that the ending factor of the wait state is due to the date changing (S704: YES), all of the named pipes each including “$DATE” in the template are closed (S708), and the named pipes are deleted from the data storage area 36 (S710). Subsequently, the serial numbers are reset (S712), and all of the deleted named pipes are again created using the same templates (S714). In this instance, “$DATE” is replaced with a new date. Thus, the processing returns again to S702, and the scan program is placed in the wait state.

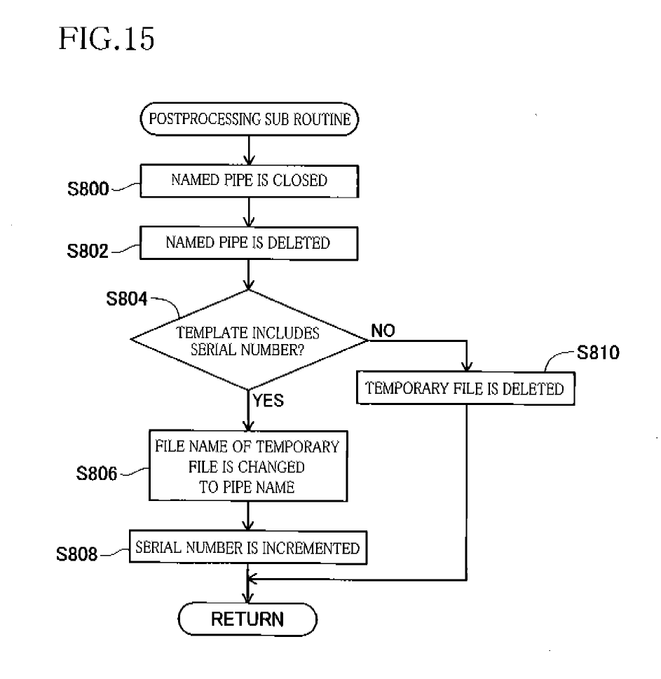

When the postprocessing sub routine is executed, the named pipe is closed, as shown in FIG. 15 (S800). Then the closed named pipe is deleted from the data storage area 36 (S802). Subsequently, the CPU 12 determines whether the template of the pipe name includes the serial number (S804). If the template of the pipe name does not include the serial number (S804: NO), the scanned data stored in the temporary file is deleted (S810). If the template of the pipe name includes the serial number (S804: YES), the file name of the temporary file is changed to the same name as the deleted named pipe (S806). Then the serial number is incremented, (S808), and the postprocessing sub routine ends. Thereafter, a new named pipe is created at S118 having a new file name including the serial number incremented at S808. Consequently, the image file remains so as to have the same name as that of the named pipe for which reading of data has been performed. Where the image processing device again reads the same file name, the image processing device re-reads the previously read image without the scanning operation being performed. In other words, the user can deal with a newly scanned image and a previously scanned image in the same sense.

### Third Embodiment

The PC 10 according to a third embodiment is configured such that the pipe name of the named pipe is not associated with the setting values of the scan operation and the setting values of the scan operation are input after the image processing program 32 has performed reading with respect to the named pipe. Inputting the setting values of the scan operation after the image processing program 32 has performed reading thereto will be explained below. The PC 10 of the third embodiment is substantially the same in configuration as the PC 10 of the first embodiment and its explanation is dispensed with.

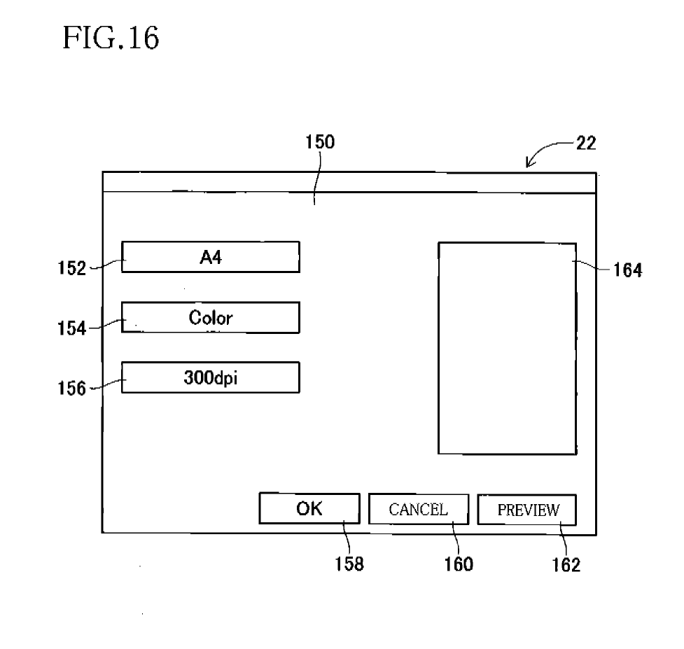

The PC 10 of the third embodiment is configured such that, when reading has occurred with respect to the named pipe having the pipe name that is not associated with the setting values of the scan operation, a setting-value input screen 150 shown in FIG. 16 is displayed on the panel 22. There are displayed, on the setting-value input screen 150, a scan-size select button 152, a scan-color select button 154, a scan-resolution select button 156, an OK button 158, a Cancel button 160, a Preview button 162, and a preview area 164.

The scan-size select button 152, the scan-color select button 154, and the scan-resolution select button 156 are respectively similar to the scan-size select button 84, the scan-color select button 86, and the scan-resolution select button 88 displayed on the setting-value input screen 80 in the first embodiment. The setting values of the scan operation are selected by operations of the respective buttons, and the scan operation based on the setting values is performed by operating the OK button 158.

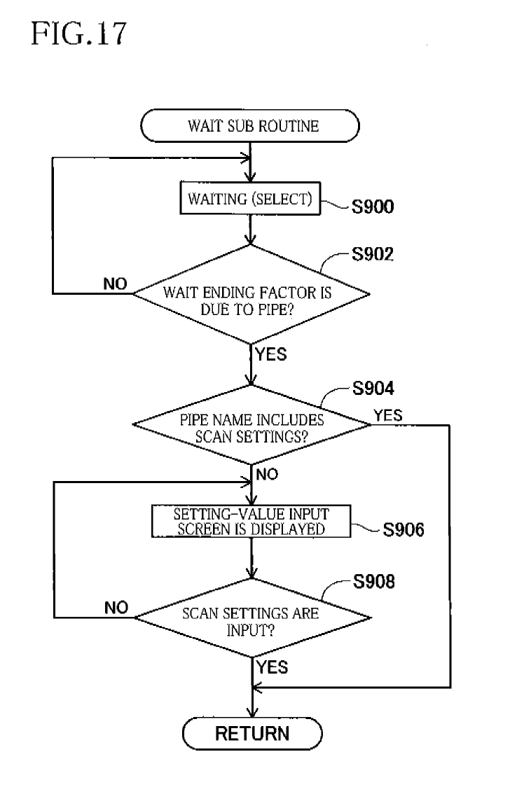

Inputting the setting values of the scan operation after the occurrence of reading with respect to the named pipe is executed by execution of the scan program 34 by the CPU 12 of the PC 10 in the third embodiment. The processing when the scan program 34 of the third embodiment is executed will be explained below. The processing when the scan program 34 of the third embodiment is executed is the same as the processing when the scan program 34 of the first embodiment is executed, except for the wait sub routine. In view of this, the processing of the wait sub routine will be explained referring to the flow chart of FIG. 17.

When the wait sub routine is executed, the scan program is placed in a wait state as shown in FIG. 17 (S900). Subsequently, the CPU 12 determines whether the ending factor of the wait state is due to an end of the opening processing with respect to the pipe and the writing permission conditions (S902). That is, the CPU 12 determines whether the wait state has ended because reading with respect to the named pipe has occurred. If the ending factor of the wait state is not due to the named pipe (S902: NO), the processing returns to S900. If the ending factor of the wait state is due to the named pipe (S902: YES), the CPU 12 determines whether the pipe name of the named pipe includes the setting values of the scan operation (S904).

If the pipe name includes the setting values of the scan operation or if associated settings are written in the setting file (S904: YES), the wait sub routine ends and the scan operation at the setting values or at the settings is performed (like the processing at S114). If the pipe name does not include the setting values of the scan operation and the associated settings are not written in the setting file (S904: NO), the setting-value input screen 150 is displayed on the panel 22 (S906) and the CPU 12 determines whether the setting values of the scan operation have been input (S908). In other words, the CPU 12 determines whether the OK button 158 has been operated after selection of the setting values of the scan operation by operations of the scan-size select button 152, and so on. If the setting values of the scan operation are not yet input (S908: NO), the processing returns to S906. If the setting values of the scan operation have been input (S908: YES), the wait sub routine ends. In this instance, the scanning operation at the settings input through the setting-value input screen 150 is performed at S114.

### Modified Examples

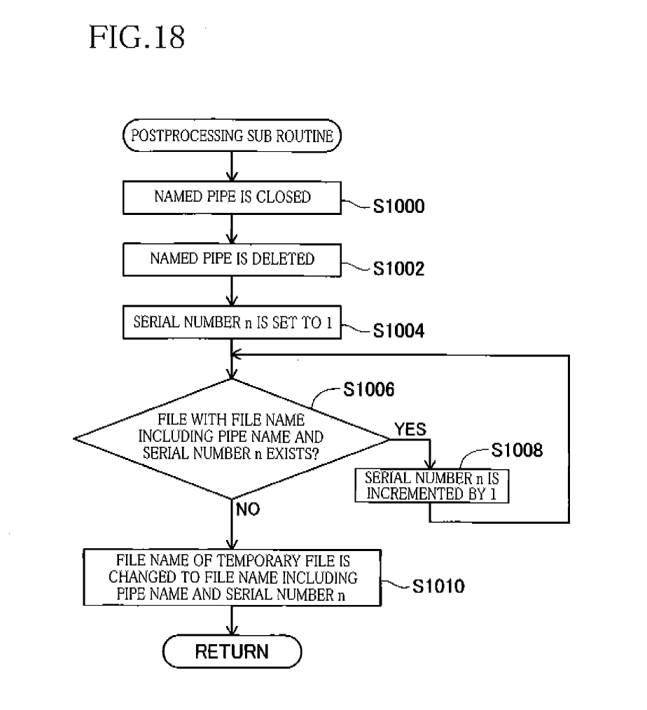

A postprocessing sub routine different from the postprocessing sub routine illustrated above will be explained as one modified example. In the postprocessing sub routine indicated by a flow chart of FIG. 18, the named pipe is disabled, namely, is closed (S1000), and the closed named pipe is deleted from the data storage area 36 (S1002). Subsequently, the serial number n is set to 1 (S1004). The CPU 12 then determines whether there exists a file having a file name that includes the pipe name and the serial number n (S1006).

If the file having the file name that includes the pipe name and the serial number n exists (S1006: YES), the serial number n is incremented by 1 (S1008) and the processing returns to S1006. If the file having the file name that includes the pipe name and the serial number n does not exist (S1006: NO), the file name of the temporary file is changed to the file name that includes the pipe name and the serial number n (S1010), and the postprocessing sub routine ends. The serial number in the modified example is different from the serial number attached to the pipe name by the macro of the information ($SERIAL) related to the serial number in the second embodiment. It is preferable not to attach the macro $SERIAL indicative of the serial number to the template of the pipe name when the modified example is practiced.

### <Functional Configuration of CPU>

The CPU 12 of the PC 10 that executes the scan program 34 is regarded to have a functional configuration shown in FIG. 1 in view of the processing executed by the CPU 12. As apparent from FIG. 1, the CPU 12 includes a reading determining section (determining section) 170, a scan-command transmitting section 172, a scanned-data receiving section 174, a scanned-data writing section 176, a pseudo-image-file creating section 178, a first pseudo-image-file deleting section 180, a second pseudo-image-file deleting section 182, a first storage control section 184, a second storage control section 186, a pseudo-image-file closing section 188, a screen display section 190, a setting-value (setting-input) receiving section 192, and an error-data writing section 194.

The reading determining section 170 is a functional section that executes the reading determining processing (determining processing) at S302, S706, S902 of the scan program 34. The scan-command transmitting section 172 is a functional section that executes the scan-command transmitting processing at S404 of the scan program 34. The scanned-data receiving section 174 is a functional section that executes the scanned-data receiving processing at S406 of the scan program 34. The scanned-data writing section 176 is a functional section that executes the scanned-data writing processing at S418 of the scan program 34. The pseudo-image-file creating section 178 is a functional section that executes the pseudo-image-file creating processing at S200, S604 of the scan program 34. The first pseudo-image-file deleting section 180 is a functional section that executes the first pseudo-image-file deleting processing at S710 of the scan program 34. The second pseudo-image-file deleting section 182 is a functional section that executes the second pseudo-image-file deleting processing at S502, S802 of the scan program 34. The first storage control section 184 is a functional section that executes the first storage control processing at S806 of the scan program 34. The second storage control section 186 is a functional section that executes the second storage control processing at S406 of the scan program 34. The pseudo-image-file closing section 188 is a functional section that executes the pseudo-image-file closing processing at S500, S800 of the scan program 34. The screen display section 190 is a functional section that executes the screen display processing at S906 of the scan program 34. The setting-value receiving section 192 is a functional section that executes the setting-value (setting-input) receiving processing at S908 of the scan program 34. The error-data writing section 94 is a functional section that executes the error-data writing processing at S424 of the scan program 34.

It is to be understood that the present invention is not limited to the details of the illustrated embodiments, but may be embodied with various changes and modifications which may occur to those skilled in the art. In the illustrated embodiments, the scanned data is obtained utilizing the scan program 34 while the image processing program 32 is being executed. The scanned data may be obtained utilizing the scan program 34 while various programs such as a document creating program and a print processing program are being executed.

The file name of the named pipe includes information relating to the date in the second embodiment. The scan program in the first embodiment may be modified such that the file name of the named pipe includes information relating to the date.

The named pipe stored in the data storage area 36 of the PC 10 in the illustrated embodiments may be stored in other devices connected to the PC 10.

The information relating to the date is included in the pipe name in the illustrated embodiment. Information relating to a time, a day of the week, and the like may be included in the pipe name.

The error information is written to the named pipe in the illustrated embodiments when the PC 10 cannot obtain the scanned data. The named pipe may be closed without the error information being written thereto.

While the processing shown in FIGS. 4-9, FIGS. 12-14, and FIG. 16 is executed by the CPU 12 in the illustrated embodiments, other devices may execute the processing. For instance, the processing may be executed by an ASIC or other logic integrated circuits. Further, the CPU, the ASIC, and other logic integrated circuits may cooperate with one another to execute the processing.

The scan processing in the illustrated embodiments is performed by use of the API. The scan processing may be performed by a call of other programs or a call of a scanner driver.

### ADVANTAGEOUS EFFECTS

According to the embodiments illustrated above, the named pipe (the pseudo image file) is virtually provided in the storage portion 14 of the PC 10 (the image processing device), and the CPU 12 determines whether the image processing program 32 (the certain program) has performed reading with respect to the named pipe. When the CPU 12 determines that the image processing program 32 has performed reading with respect to the named pipe, the scan command is transmitted to the scammer 60 (the scanning device). When the PC 10 receives, form the scanner 60, the scanned data as a reply to the scan command, the received scanned data is written to the named pipe and the scanned data written to the named pipe is read by the image processing program 32. Thus, the embodiments enable the image processing program 32 that cannot call the API of the scanner driver to read in the scanned data in a simplified manner.

What is claimed is:

1. A computer-readable non-transitory storage medium storing a scan program executable by a computer of an image processing device including a communication portion configured to be communicable with a scanning device and a storage portion configured to store a certain program,
the scan program, when executed by the computer, causing the image processing device to execute:
determining processing in which the image processing device determines whether a pseudo image file is read by the certain program;
scan-command transmission processing in which, when the image processing device determines that the pseudo image file is read by the certain program in the determining processing, the image processing device transmits a scan command to the scanning device via the communication portion;
scanned-data receiving processing in which the image processing device receives scanned data from the scanning device via the communication portion as a reply to the scan command; and
scanned-data writing processing in which the image processing device writes the scanned data received from the scanning device to the pseudo image file.

2. The computer-readable non-transitory storage medium according to claim 1, wherein, when executed by the computer, the scan program causes the image processing device to execute pseudo-image-file creating processing in which the image processing device creates the pseudo image file.

3. The computer-readable non-transitory storage medium according to claim 2,
wherein, in the pseudo-image-file creating processing, the image processing device creates the pseudo image file having a file name that contains time-related information that relates to time at a time point of creation of the pseudo image file, and
wherein, when executed by the computer, the scan program causes the image processing device to execute first pseudo-image-file deleting processing in which the image processing device deletes the pseudo image file when a specific time has elapsed after the time point of creation of the pseudo image file in the pseudo-image-file creating processing.

4. The computer-readable non-transitory storage medium according to claim 2,
wherein, in the pseudo-image-file creating processing, the image processing device creates the pseudo image file having a file name that contains time-related information that relates to time at a time point of creation of the pseudo image file, and
wherein, when executed by the computer, the scan program causes the image processing device to execute first pseudo-image-file deleting processing in which the image processing device deletes the pseudo image file when time indicated by the time-related information does not match a current time.

5. The computer-readable non-transitory storage medium according to claim 3, wherein, in the pseudo-image-file creating processing, the image processing device creates another pseudo image file in place of the pseudo image file that has been deleted in the first pseudo-image-file deleting processing, said another pseudo image file having a file name that contains time-related information different from the time-related information contained in the file name of the deleted pseudo image file.

6. The computer-readable non-transitory storage medium according to claim 2, wherein, in the pseudo-image-file creating processing, the image processing device creates the pseudo image file with respect to which only reading-in of data in the pseudo image file is allowed for a program other than the scan program.

7. The computer-readable non-transitory storage medium according to claim 2,
wherein, in the pseudo-image-file creating processing, the image processing device creates the pseudo image file in association with any of a plurality of setting values set for a scan operation by the scanning device, and
wherein, in the scan-command transmission processing, the image processing device transmits, to the scanning device via the communication portion, the scan command including said any of the plurality of setting values associated with the pseudo image file for which the image processing device determines that the pseudo image file is read by the certain program.

8. The computer-readable non-transitory storage medium according to claim 1,
wherein the image processing device further includes a display portion and an input portion,
wherein, when executed by the computer, the scan program causes the image processing device to execute:
screen displaying processing in which, when the image processing device determines that the pseudo image file is read by the certain program in the determining processing, the image processing device causes the display portion to display a setting screen for receiving any of a plurality of setting values for a scan operation by the scan device; and
setting-input receiving processing in which, the image processing device receives, from the input portion, input designating one of the plurality of setting values, and
wherein, in the scan-command transmission processing, the image processing device transmits, to the scanning device via the communication portion, the scan command including said any of the plurality of setting values received in the setting-input receiving processing.

9. The computer-readable non-transitory storage medium according to claim 2,
wherein, when executed by the computer, the scan program causes the image processing device to execute:
second pseudo-image-file deleting processing in which the image processing device deletes the pseudo image file when reading-in of data in the pseudo image file by the certain program is completed; and
first storage control processing in which the image processing device stores, in the storage portion, the scanned data received in the scanned-data receiving processing in association with a file name of the pseudo image file deleted in the second pseudo-image-file deleting processing, and
wherein, in the pseudo-image-file creating processing, the image processing device creates another pseudo image file having a file name different from the file name of the pseudo image file deleted in the second pseudo-image-file deleting processing.

10. The computer-readable non-transitory storage medium according to claim 1,
wherein, when executed by the computer, the scan program causes the image processing device to execute second storage control processing in which, when reception of the scanned data in the scanned-data receiving processing is completed, the image processing device stores the reception-completed scanned data in the storage portion, and
wherein, in the second storage control processing, every time the reception of the scanned data in the scanned-data receiving processing is completed, the image processing device stores the reception-completed scanned data in association with a unique file name.

11. The computer-readable non-transitory storage medium according to claim 10, wherein, in the second storage control processing, the image processing device stores the reception-completed scanned data together with the file name containing at least time-related information that relates to a time at a time point of storage of the reception-completed scanned data.

12. The computer-readable non-transitory storage medium according to claim 1, wherein, when executed by the computer, the scan program causes the image processing device to execute pseudo-image-file closing processing in which, when reception of the scanned data in the scanned-data receiving processing has not been executed properly, the image processing device closes the pseudo image file.

13. The computer-readable non-transitory storage medium according to claim 1, wherein, when executed by the computer, the scan program causes the image processing device to execute error-data writing processing in which, when reception of the scanned data in the scanned-data receiving processing has not been executed properly, the image processing device writes data for indicating an error.

14. The computer-readable non-transitory storage medium according to claim 1,
wherein the pseudo image file is configured such that, when writing of data to the pseudo image file is performed, next writing thereto is delayed until the written data is read out therefrom, and
wherein, when the writing to the pseudo image file is allowed, the image processing device determines that the reading has been performed with respect to the pseudo image file.

15. The computer-readable non-transitory storage medium according to claim 14, wherein the pseudo image file is a named pipe.

16. An image processing device comprising: a communication portion configured to be communicable with a scanning device; and a controller,
wherein the controller is configured to:
determine whether a pseudo image file is read by a certain program;
transmit a scan command to the scanning device via the communication portion when the controller determines that the pseudo image file is read by the certain program;
receive scanned data from the scanning device via the communication portion as a reply to the scan command; and
write the scanned data received from the scanning device to the pseudo image file.
